(19) United States
(12) Patent Application Publication
(10) Pub. No.: US 2025/0132556 A1
(43) Pub. Date: Apr. 24, 2025

(54) Method and Device for Protecting One or More Electrical Loads in the Event of a Short Circuit

(71) Applicant: HKR Automotive GmbH, Kupferzell (DE)

(72) Inventor: Ralf Abel, Krautheim (DE)

(21) Appl. No.: 18/293,151

(22) PCT Filed: Jul. 27, 2022
(86) PCT No.: PCT/EP2022/071058

§ 371 Date: Jan. 29, 2024

(30) Foreign Application Priority Data
Jul. 30, 2021 (DE) 10 2021 119 901.8
Jul. 15, 2022 (DE) 10 2022 117 765.3

(51) Int. Cl. H02H 3/44; H02H 1/04; H02H 3/06; H02H 3/087

(52) U.S. Cl. CPC H02H 3/44; H02H 1/043; H02H 3/06; H02H 3/087

(57) ABSTRACT

A method of protecting an electrical load (L) connectable to an electrical power source (B) via a switch (S), in the event of short circuit of the load (L), comprises the following steps of: connecting the load (L) to the electrical power source (B) by a first switching-on of the switch (S), detecting an output current (IA) of the switch (S), switching off the switch (S), when the output current (IA) exceeds an overcurrent threshold (IA_S) and/or a predetermined period of time (TD) has elapsed since the first switching-on of the switch (S), detecting an output voltage (UA) of the switch (S), determining an output voltage difference (AUA) of the output voltage (UA) between a predetermined first point in time (T1) and a predetermined second point in time (T2) after the first point in time (T1), a second switching-on of the switch (S), when the output voltage difference (AUA) is negative and has an absolute value that is less than an upper output voltage difference threshold (AUA_S1), and/or the switch (S) was switched off after the predetermined period of time (TD) and the detected output current (IA) has not exceeded the overcurrent threshold (IA_S) since the first switching-on at least until the switching-off.

The present invention relates to a method and a device for protecting one electrical load or more electrical loads in the event of a short circuit of the one or more loads.

Modern electronic systems are designed to have a high degree of integration so as to be powerful and to offer a plurality of functions. In so doing, also different supply voltages are used to support different types of loads for proper operation thereof. One of the most important requirements is a minimum downtime of the system in the case of transient abnormal events such as overload, overvoltage or short circuit. Therefore, protective devices such as melt fuses or nowadays also so-called E-fuses or electronic fuses are used to cope with inrush currents, overload, overcurrent, short circuits and overvoltages and to protect the sensitive loads for a reliable system operation. The main requirement consists in reducing the fault currents to within the limits and restoring the system to the active state as soon as the fault is eliminated without any manual intervention being required.

Melt fuses are traditionally regarded as protective devices which are used to insulate overload or short circuit faults from the main system. Although those fuses offer protection, the fault current must be by far higher than the nominal current of the fuse, the response time ranging from milliseconds to seconds. This makes it extremely difficult to predict the exact overcurrent level at which the fuse is triggered. A conservative selection of the nominal current of the fuse can result in the fuse being triggered at inrush current events. In addition, the fuse must be physically replaced as soon as it blows during an overload event, causing an increase in the downtime of the system and the maintenance cost. On the other hand, PTC resistors offer a resettable overcurrent protection and, in contrast to a fuse, can avoid the physical intervention. As they are activated by the heating effect of an overcurrent load, however, their reaction time is limited to several milliseconds. Moreover, the switch-on resistance of PTC fuses increases after each reset, which gives rise to concerns regarding a repeatable performance over time.

The best way to avoid system failures consists in detecting, reacting to and correcting potentially adverse conditions as soon as possible. Since the response of melt fuses and PTC resistors depends on the heating (temperature), a lot of system developers prefer using the current as an indicator to guarantee an efficient circuit protection. Both melt fuses and PTC resistors do not meet many of the protection requirements, such as control of inrush currents, overvoltage, reverse current and reverse voltage protection, which are required in modern electronic systems.

An aspect to be taken into consideration also resides in the reaction of the system in the event of a short circuit depending on the type of electrical load in which the short circuit occurs. In the automotive sector, for example short circuits may occur by marten damage, an insulation damaged by an accident or insulation damage by faulty handling or ageing effects. These causes may occur both in the switched-off state of an electronic fuse and in active driving operation. The loads can be roughly classified into ohmic, inductive and capacitive loads which react differently to a short circuit and an inrush current. It should be possible to manufacture a protective device, i.e. generally a fuse device, preferably independently of its use for a later load, and also later in its operation the protective device should be independent thereof. It is not possible to conclude the type of input impedance or the amount of input impedance by means of the nominal current of the fuse.

Ohmic loads do not entail increased currents either upon switching on or upon switching off. Inductive loads attempt to maintain the current flow during switch-off. In contrast to that, in capacitive loads, specifically with ideal capacities, the impedances are low so that, in particular upon switching on, at the beginning the switch-on current of a capacitive load in the event of short circuit differs only insignificantly from the event without short circuit. This turns out to be critical during a quick switch-on operation. In a vehicle, e.g. in active driving operation the input capacitor has been charged so that it is not necessary to discriminate or determine a case of capacitive load here. After voltage-free parking (e.g. overnight in the garage) the discrimination has to be made, however.

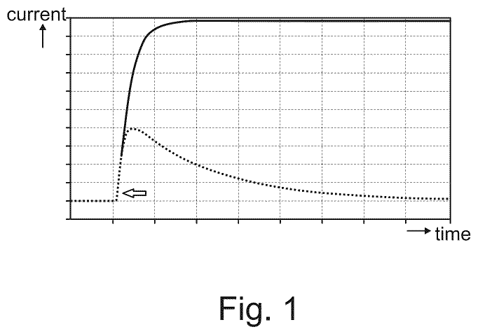

FIG. 1 illustrates a diagram with a current curve in the event of short circuit (solid line) and a current curve with a normal inrush current (broken line).

The normal inrush current may be uncritical such as in vehicles, as the starting process there typically takes place before the start of travel and is terminated before traveling; the short circuit current is critical, on the other hand. Since both current curves are approximately identical at the beginning as above described, however, during operation a discrimination between the critical event of short circuit and the normal starting current can be made only after a certain period of time (which is dependent on the current gradient (capacity, multiplier, inductance of leads); typical range from 20 to 50 μs; in terms of current in the range of >>100A). A fuse is intended to be triggered at an overload (overcurrent). Moreover, the fuse should be designed so that it is triggered only in the event of a short circuit but not in the event of an uncritical inrush current. However, this is in contradiction to the desire of a quick triggering of the fuse.

Thus, conventionally even for electronic fuses at least one component (switch or additional resistor) is required and used, resp., which has a by far higher loss capacity or thermal capacity than it is necessary for normal operation. This results in increased cost.

When protecting loads via a summation current measurement as in multi-channel modules in which all loads or channels are switched off, if an overcurrent occurs even in one channel or in one load only, the individual current of one branch or one load can be determined e.g. by measuring the switch voltage, to be sure, but an information about the channel or the load in which the short circuit occurs or has occurred is not available to the whole system or module. That is, in the case of summation current fault such as exceeding a threshold thereof, the electronic fuse deactivates all channels. This means that all channels which exhibit no fault or short circuit are also deactivated.

However, this requires that all channels exhibiting no fault are activated again as early and quickly as possible. In a normal connection procedure in the automotive sector, this takes several milliseconds, allowing load modules to possibly go to reset, and then a re-activation in turn taking several milliseconds. Therefore, the time interval for connection or activation in automotive electronics is desired to be less than 100 μs.

It is therefore the object of the invention to provide a method and a device for protecting a load in the event of a short circuit which can react more quickly and more cost-efficiently to a short circuit. The object is solved by a method according to claim 1 and by a device according to claims 13 and 14, respectively.

In addition, it is an object of the invention to provide a method and a device for protecting a plurality of electrical loads in the event of a short circuit of at least one of the loads using a summation current measurement which can react more quickly and more cost-efficiently to a short circuit. The object is solved by a method according to claim 15 and by a device according to claims 24 and 25, respectively.

The dependent claims relate to advantageous embodiments of the invention.

In accordance with the invention, a method of protecting an electrical load in the event of a short circuit of the load is provided, the electrical load being configured to be connected to an electrical power source via a switch, the method comprising the steps of: connecting the load to the electrical power source by: a first switching-on of the switch, detecting an output current of the switch, switching off the switch, when the output current exceeds an overcurrent threshold and/or a predetermined period of time has elapsed since the switch was switched on, detecting an output voltage of the switch, determining an output voltage difference of the output voltage between a predetermined first point in time and a predetermined second point in time after the first point in time, a second switching-on of the switch, when the output voltage difference is negative and has an absolute value which is less than an upper output voltage difference threshold and/or the switch was switched off after the predetermined period of time and the measured output current has not exceeded the overcurrent threshold since the first switching-on of the switch until at least the switching-off of the switch.

The electrical power source preferably corresponds to a power source of a system in which the load is or shall be inserted. In a vehicle, this can be a vehicle battery having the capacities usual there of e.g. 12 V or 24 V D.C.

In accordance with the invention, it is detected by a temporal short test sequence, which is nearly not relevant to the load, right at the start when the current is still low (see range of the arrow in FIG. 1) whether an uncritical current curve (broken like in FIG. 1) such as an uncritical inrush current or a critical current curve such as a short circuit (solid line in FIG. 1) has to be expected.

Preferably, the predetermined period of time is within a range from 1 to 100 μs. By such a short starting pulse, in the case of a capacitive load the capacitor thereof is charged very quickly (for example for a MOSFET with minimum charging resistance and switching resistance R_{DSon}). The capacity and, resp., the capacitor then discharges after switch off via the internal load (resistors) which is different from the short circuit load (mainly at voltages in the range below the minimum functional voltage, most system modules are deactivated so that the internal load results from the current drain of the control electronics).

Preferably, the overcurrent threshold is defined so that the switch is switched off by exceeding the overcurrent threshold by the output current not later than 100 μs, further preferred 10 μs, after the first switching-on.

Preferably, the overcurrent threshold amounts to at least 70% of the nominal current of the load. Even when switching-off in case of an overcurrent is performed, this is done within short time, i.e. within the above range of the predetermined period of time from 1 to 100 μs, for example.

Preferably, the first point in time is equal to the point in time of switching-off the switch or is after the point in time of switching-off the switch. The first point in time is advantageously as closely as possible after the time of the switching-off the switch, if a usable voltage value can be determined. Thus, the execution of the method according to the invention can be accelerated.

Preferably, the second point in time is within a range from 100 to 1000 μs after the first point in time. In this case, too, it applies that the second point in time is as early as possible and realizable after the first point in time to enable to determine the voltage gradient as quickly and reliably as possible.

Preferably, the upper output voltage difference threshold is set depending on the output voltage after switching-off the switch. In this way, the upper output voltage difference threshold can still be adjusted or can be adjusted in repeated cycles.

Preferably, an initial value of the upper output voltage difference threshold is in a range from 100 to 200 mV/s.

Preferably, the load is a vehicle load, specifically a motor vehicle load. The broader term of vehicle in this case covers, apart from motor vehicles such as cars, also motorcycles, aircraft, ships and, where appropriate, rail vehicles.

Preferably, the method according to the invention is carried out at the beginning of switching-on operation of the load for operation thereof. In a motor vehicle, for example, the switching-on process of the load is typically carried out before the start of travel so that short-term current peaks (higher inrush current) are not safety-relevant, as the switching-on process is terminated before the actual start. This applies also to other corresponding systems in which the switching-on operation is terminated before the actual operation.

Preferably, when after the first switching-on of the switch the output current has exceeded the overcurrent threshold and the output voltage difference is negative, it is determined that the load is a capacitive load.

Preferably, the first switching-on of the switch generates a start-up pulse which, if the load is a capacitive load, results in the output current (IA) exceeding the overcurrent threshold. The overcurrent threshold should be exceeded as quickly as possible so that the switch for the method according to the invention is quickly switched off again and, thus, the further evaluation of the voltage(s) and the current, where appropriate, can be carried out quickly.

According to the invention, furthermore a method of protecting a plurality of electrical loads connectable to an electrical power source via respective switches in the event of a short circuit of at least one of the loads is provided, wherein a sum of respective currents of the loads is detected as a summation current, and wherein, when the summation current exceeds a predetermined summation current threshold, the switches are switched off. The method comprises the steps of: after switching-off the switches due to the summation current exceeding the summation current threshold, for at least a first switch among the switches which is associated with a capacitive load among the loads, (i) detecting an output voltage of the first switch during a preset detection period after switching-off the first switch, (ii) when the output voltage during the preset detection period is or becomes less than a preset voltage threshold, maintaining the switch-off state of the first switch, and (iii) when the output voltage during the preset detection period is not or does not become less than the preset voltage threshold, switching on the first switch after expiry of the preset detection period. If plural capacitive loads are provided, they or the voltages thereof can be individually checked preferably parallel in time during the detection period. The term “during” thus specifically comprises the fact that falling below the voltage threshold does not take place during the whole detection period but occurs only sometime in the detection period, because discharge of the capacity takes some time, even if it happens relatively quickly.

The electrical power source can correspond to the above-mentioned electrical power source.

Preferably, after switching off the switches due to the summation current exceeding the summation current threshold, for at least a second switch among the switches which is associated with an ohmic or inductive load among the loads, the second switch is switched on and a current flowing through the second switch is determined, and if the determined current exceeds an overcurrent threshold, the second switch is (finally) switched off.

Accordingly, preferably the switching-on of the second switch, the determination of the current flowing through the second switch and the switching-off of the second switch are carried out sequentially for several or all of the second switches, namely further preferably after expiry of the preset detection period, so that the ohmic and inductive loads are checked after checking of the capacitive loads.

The detection period can start with switching-off the switches due to the fact that the summation current exceeds a preset summation current threshold and the detection period can be less than or equal to 100 μs, preferably less than or equal to 20 μs. Further preferred, it is in the range from 10 to 20 μs. Quick measurement of the output voltage in this time range is possible specifically in automotive engineering.

Preferably, the preset voltage threshold is equal to or less than 5 V, further preferably equal to or less than 3 V. If, e.g., the output voltage of the capacitive load and, resp., the corresponding switch after switching-off is within 10 to 20 μs, the output voltage in automotive electronics typically is in a range from 3 to 5 V, if there is no short circuit. If, on the other hand, the output voltage within the detection period is less than 3V, one can assume that there is a short circuit in said capacitive load.

If the output voltage during the preset detection period is less than the preset voltage threshold, a corresponding first fault information can be stored in association with the capacitive load associated with the first switch, and if the determined current of an ohmic or inductive load exceeds an overcurrent threshold, a corresponding second fault information can be stored in association with the ohmic or inductive load associated with the second switch. This information can be read out later at the workshop, for example, and can be used for repairs.

Information about a respective type of the specific loads can be stored in advance and this information then can be referred to, when it is to be determined according to the invention at which load a short circuit has occurred so as to permanently deactivate said load, and at which load no short circuit or fault has occurred so as to activate said load again. The type of the respective loads can be determined and stored in advance, for example in an activation phase, in accordance with the above method of protecting an electrical load according to the invention in which switching-off according to summation current measurement does not yet take place. In the actual further operation, the switching-off according to summation current measurement and subsequent checking of the individual loads regarding the occurrence of a short circuit can be carried out.

In the following, preferred embodiments of the invention are described with reference to the drawings, wherein:

FIG. 1 shows a functional diagram to illustrate the current curves in the event of an inrush current and a short circuit of a capacitive load;

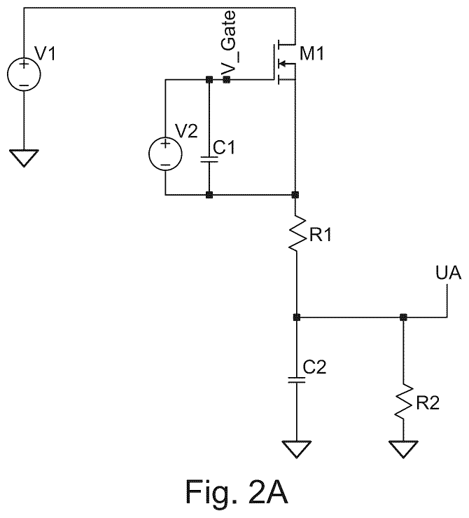

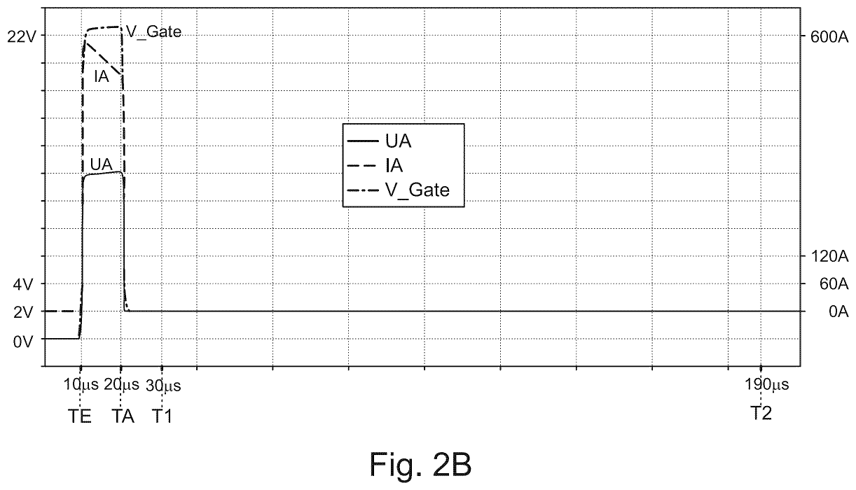

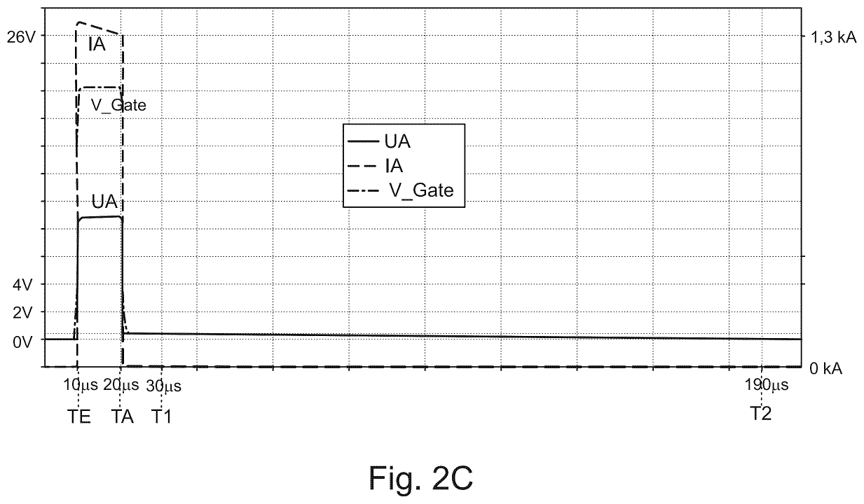

FIG. 2A shows an electric diagram to simulate current curves for a capacitive load;

FIG. 2B shows a diagram of the curves of the gate voltage or input voltage of the switch, of the load current and the load voltage for a capacitive load without a short circuit, concerning FIG. 2A;

FIG. 2C shows a diagram of the curves of the gate voltage or input voltage of the switch, the load current and the load voltage for a capacitive load with a short circuit, concerning FIG. 2A;

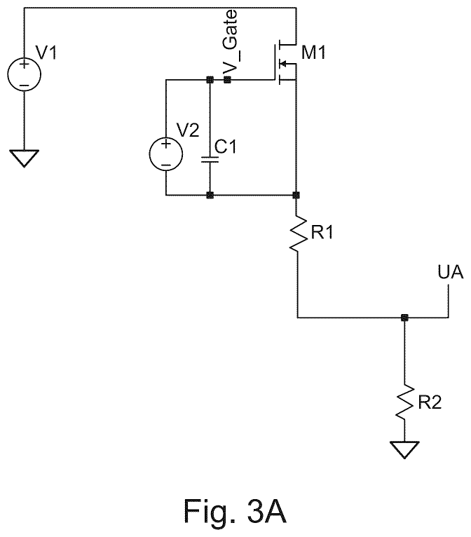

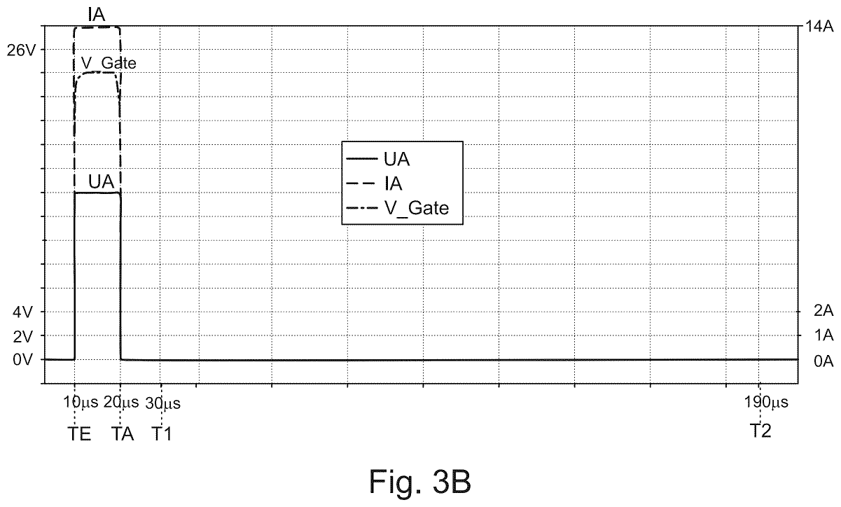

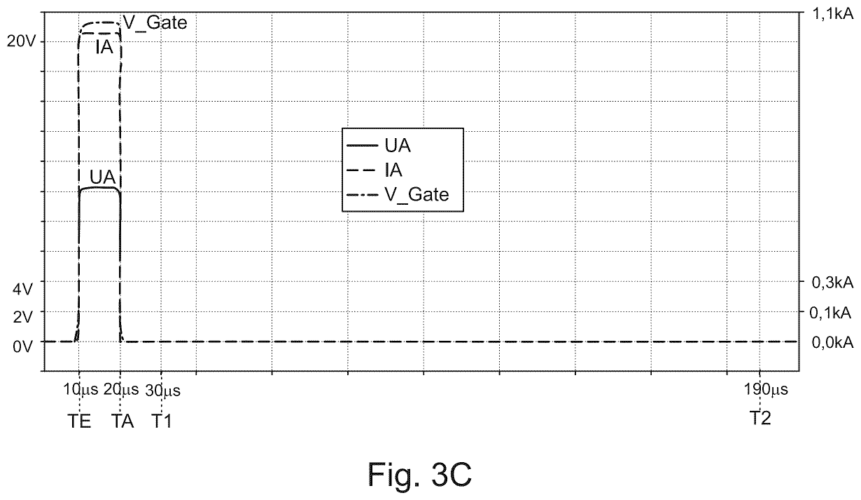

FIG. 3A shows an electric diagram to simulate current curves for an ohmic load;

FIG. 3B shows a diagram of the curves of the gate voltage or input voltage of the switch, the load current and the load voltage for an ohmic load without a short circuit, concerning FIG. 3A;

FIG. 3C shows a diagram of the curves of the gate voltage or input voltage of the switch, the load current and the load voltage for an ohmic load with a short circuit, concerning FIG. 3A;

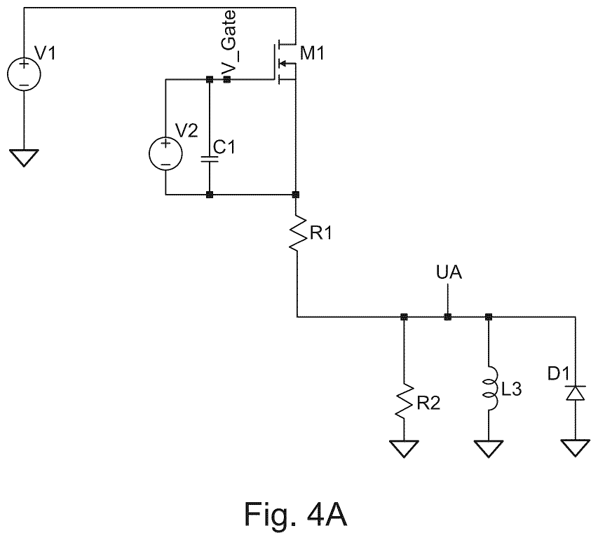

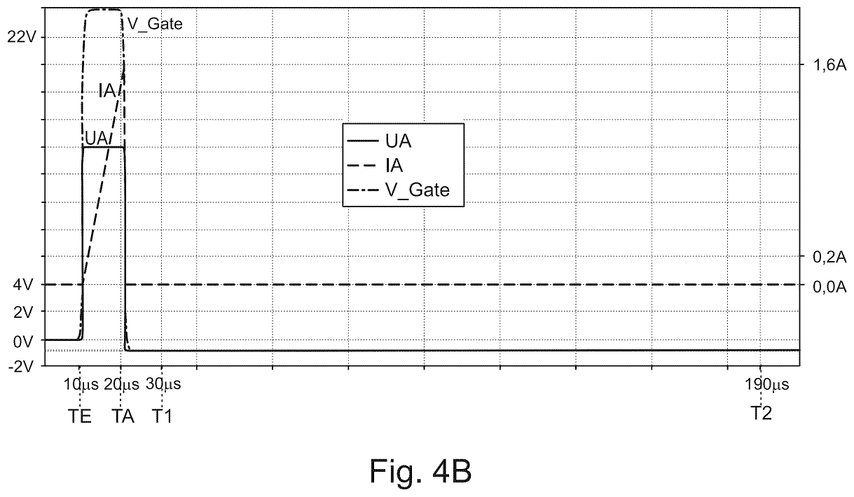

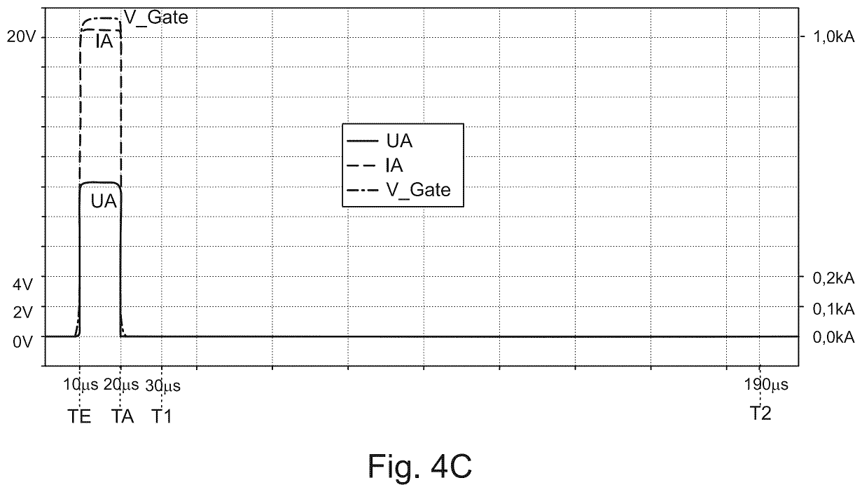

FIG. 4A shows an electric diagram to simulate current curves for an inductive load;

FIG. 4B shows a diagram of the curves of the gate voltage or input voltage of the switch, the load current and the load voltage for an inductive load without a short circuit, concerning FIG. 4A;

FIG. 4C shows a diagram of the curves of the gate voltage or input voltage of the switch, the load current and the load voltage for an inductive load with a short circuit, concerning FIG. 4A;

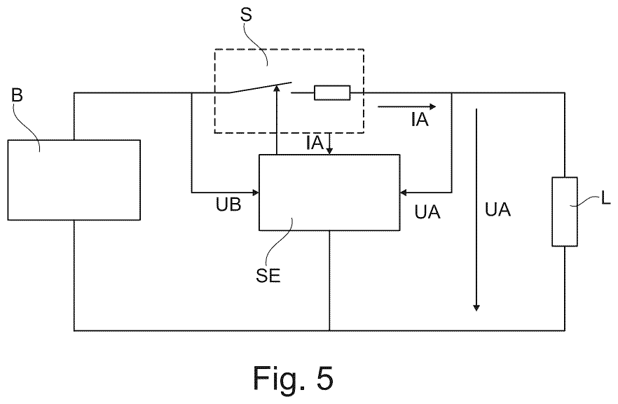

FIG. 5 shows a block diagram of an exemplary system for protecting a load in which the protection device according to the invention is used;

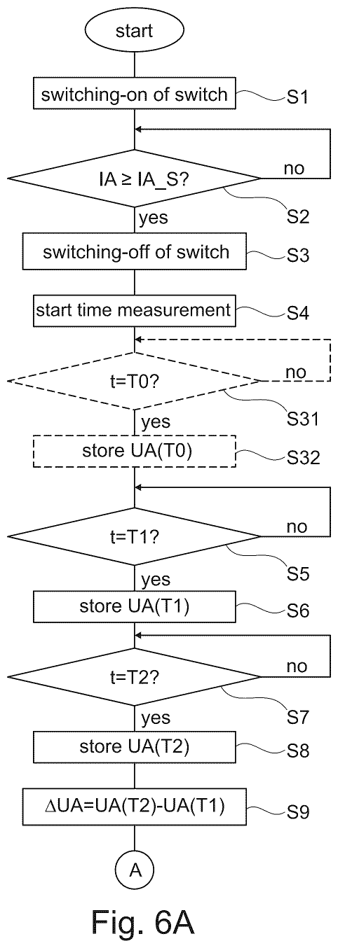

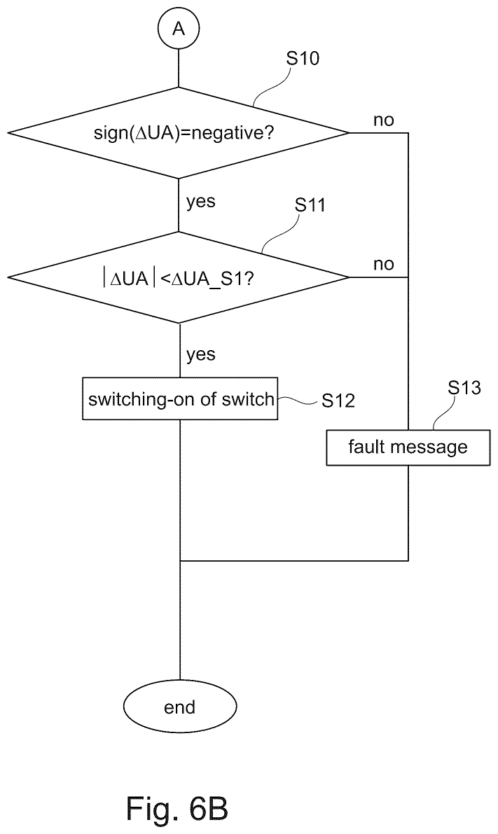

FIG. 6A shows the first part of a flow diagram of a first embodiment of a method of protecting a load in the event of short circuit according to the invention;

FIG. 6B shows the second part of the flow diagram of the first embodiment of the method of protecting a load in the event of short circuit according to the invention;

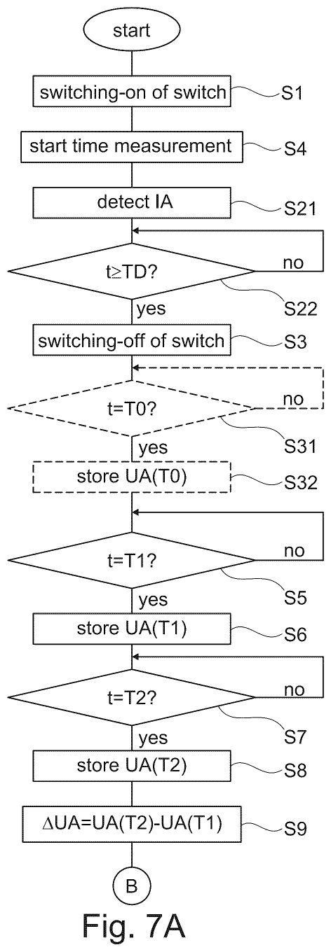

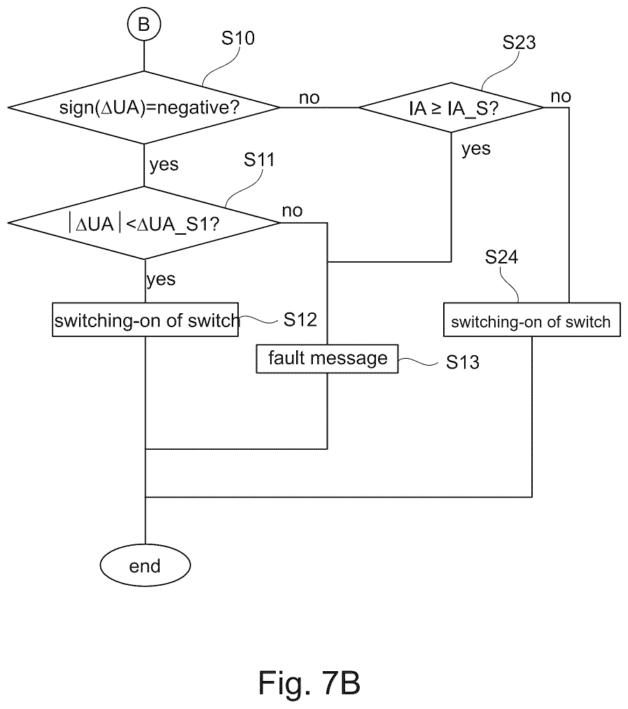

FIG. 7A shows the first part of a flow diagram of a second embodiment of a method of protecting a load in the event of short circuit according to the invention;

FIG. 7B shows the second part of the flow diagram of the second embodiment of the method of protecting a load in the event of short circuit according to the invention;

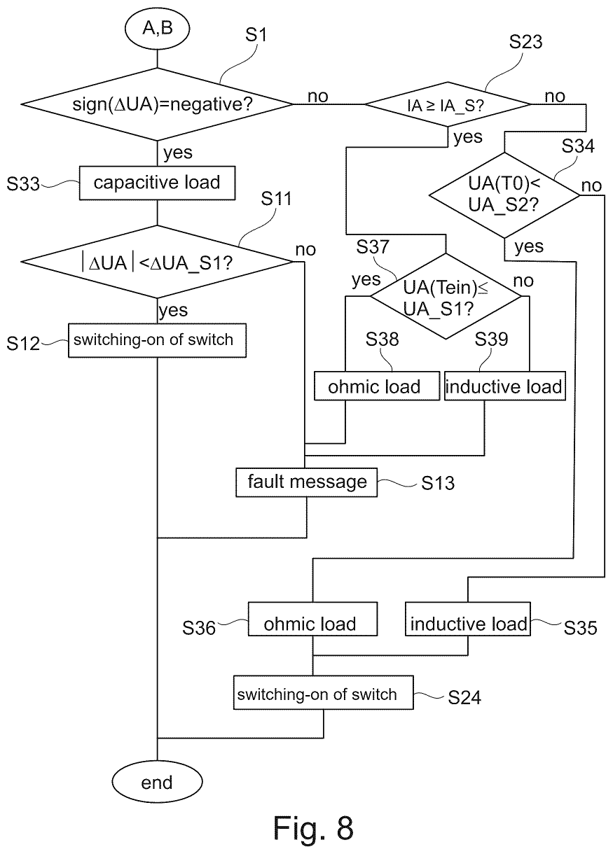

FIG. 8 shows part of a flow diagram of a third embodiment of the method of protecting a load in the event of short circuit according to the invention;

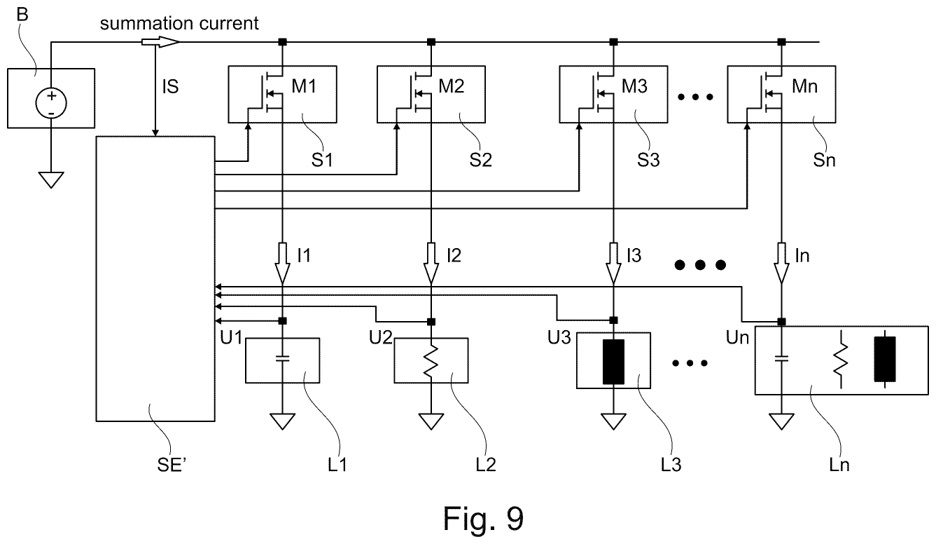

FIG. 9 shows a diagram to illustrate a module with summation current switch-off in the event of short circuit in at least one load;

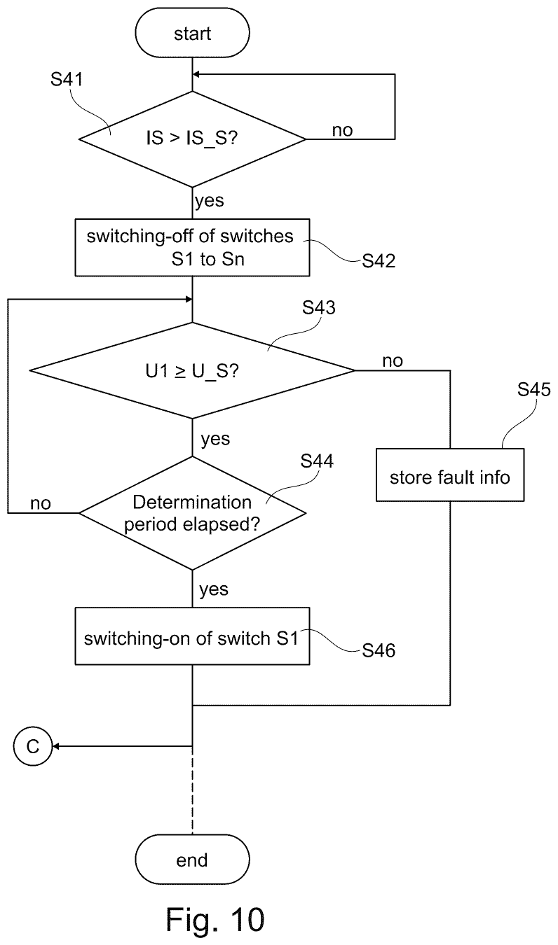

FIG. 10 shows a first part of a flow diagram of a method of protecting plural loads in the event of short circuit according to the invention as set forth in a fourth embodiment; and

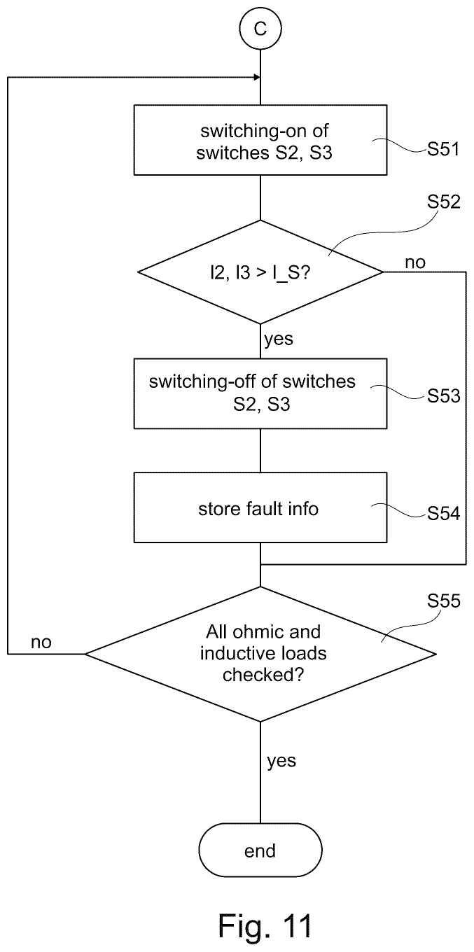

FIG. 11 shows a second part of the flow diagram of the method of protecting plural loads in the event of short circuit according to the invention as set forth in the fourth embodiment.

To start with, typical current and voltage curves of ohmic, inductive and capacitive loads in the event of a short circuit and in the event without a short circuit shall be described by means of a simulation. The capacitive loads include e.g. the radiator fan electronics, brushless DC motors, PWM controllers for DC motors and capacitive input filters. All modules which internally reduce the input voltage by switching on and off have to be equipped with such a capacitive input filter for reasons of electromagnetic compatibility (EMC). An ohmic load is, e.g., a PTC heater, i.e., a diesel auxiliary heater or an interior heating in a motor vehicle. An inductive load is, for example, an unregulated magnetic valve.

FIG. 2A illustrates a circuit diagram to simulate a capacitive load including a field effect transistor as switch M1, a voltage source V1 connected to the source terminal of the field effect transistor, a further voltage source V2 with a capacity C1 connected in parallel, which are connected to the gate terminal of the field effect transistor, a resistor R1 connected to the emitter terminal of the field effect transistor as well as a capacity C2 as capacitive load and a resistor R2 connected in parallel thereto.

For simulating the capacitive load without short circuit, inter alia the following values were used: R2=10 kΩ; R1=1 mΩ; C2=3000 μF.

FIG. 2B illustrates the result of simulation for a capacitive load without short circuit, the solid line showing the voltage UA, the broken line showing the current IA and the alternately dot-dashed line showing the gate voltage V-gate. The abscissa indicates the time, and the ordinate on the left indicates the voltage by volts and on the right indicates the current by amperes. At the point in time TE (here 10 μs) a voltage pulse (here 23 V) was applied to the switch M1 (see alternately dot-dashed line) to switch on the same, and at the point in time TA (here 20 μs) the voltage was set to zero to switch off the switch M1.

The current IA or I(R1) and the voltage UA rise correspondingly abruptly and, after switching-off the switch M1, subside almost abruptly, i.e. immediately, again, but not to zero. The voltage UA at the point in time T1 (here 30 μs) is equal to UA(T1)=2000 mV and at the point in time T2 (here 190 μs) is equal to UA(T2)=1999.99 mV. Thus, for the gradient of the voltage UA after switching-off the switch, which can be expressed e.g. by the difference of the two voltages, i.e., ΔUA=UA(T1)−UA(T2), ΔUA=−10 μV/160 μs=−0.0625 V/s is applicable. Attention also has to be paid to the negative sign of the gradient ΔUA. The current IA in the respective switch-off state is equal to zero.

The following general characteristics can be derived:
current gradient and current amplitude IA are very high;
“voltage UA during switch-on” depends on the capacity and the charging resistance (lead resistances, switch resistance, lead inductances);
the lower the charging resistances, the higher the amplitude “UA during switch-on”;
the higher the capacity, the lower the amplitude “UA during activation”, and the lower the voltage gradient “ΔUA after switching-off”.

For relevant capacitive loads, i.e. for an input capacity>100 μF, in the case of a low-impedance electrical system of a motor vehicle the current will typically generate an overcurrent condition. This results in the switching-off of the switch (e.g. MOSFET). Alternatively, the temporal short switching-on can also take place time-controlled in the typical time range from 1 to 1000 μs. Both cases excel by a very high short-term current drain.

FIG. 2C shows the simulation result corresponding to FIG. 2B for a capacitive load with short circuit, wherein R2=10mΩ was used in the simulation here. Although, under the conditions which are otherwise equal to FIG. 2B, the voltage drops immediately after switching-off, it does not immediately or quickly reach zero, however. In this case, the voltage UA(T1)=442 mV and the voltage UA(T2)=76 mV so that the gradient or the difference of the two voltages is not equal to zero, i.e., ΔUA=UA(T1)−UA(T2)=−316 mV/160 μs=−1.975 V/s. Attention has also paid to the fact that the gradient has a negative sign. The current IA in the respective switch-off state is equal to zero. As compared to the case in FIG. 2B, the amount or absolute value of the voltage gradient ΔUA is distinctly larger, however.

The following characteristics can be derived:
current gradient and current amplitude IA are very high;
“voltage UA during switch-on” depends on the capacity and the charging resistance (lead resistances, switch resistance, lead inductances);
the lower the charging resistances, the higher the amplitude “UA during switch-on”;
the higher the capacity, the lower the amplitude “UA during switch-on”, and the lower the voltage gradient “ΔUA after switching-off”.

Since in automotive electronics most loads have capacitive input filters, for example, such an input capacity is discharged slowly by a normal load current, but is discharged comparatively quickly by a short circuit, as is clear from the FIGS. 2B and 2C.

FIG. 3A illustrates a circuit diagram corresponding to FIG. 2A for simulating an ohmic load, wherein here the capacity C2 is not provided and switched, resp., but the resistor R2 constitutes the ohmic load.

FIG. 3B illustrates the simulation result corresponding to FIG. 2B for an ohmic load without short circuit. For simulating the ohmic load without short circuit, inter alia the following values were used: R2=1Ω, R1=1 mΩ. Otherwise, possibly the same values of the parameters as in the FIGS. 2A, 2B, 2C were used.

The current IA and the voltage UA rise correspondingly abruptly and after switching-off the switch M1 subside almost abruptly, i.e., immediately, to zero again. The voltage UA at the point in time T1 (here 30 μs) and at the point in time T2 (here 190 μs) is equal to zero. Thus, also the gradient of the voltage UA which can be expressed, for example, by the difference of the two voltages, i.e., ΔUA=UA(T1)−UA(T2), is equal to zero. The current IA in the respective switch-off state is equal to zero.

The following general characteristics can be derived:
the voltage UA and the current IA have an identical curve;
directly after switching-off, the voltage UA has a voltage gradient and an absolute value of 0V;
no overcurrent condition is reached.

FIG. 3C illustrates the result of simulation corresponding to FIG. 3B for an ohmic load with short circuit, wherein R2=10 mΩ was used in the simulation here. Under the conditions otherwise equal to FIG. 3B, the voltage after switching-off drops immediately to zero again, but does not immediately or quickly reach zero. Thus, also the gradient of the voltage UA which can be expressed e.g. by the difference of the two voltages, i.e., ΔUA=UA(T1)−UA(T2), is equal to zero. The current IA in the respective switch-off state is equal to zero. However, while the switch is in the switch-on state, the current UA is less than in the case of FIG. 3B due to the smaller value of the resistance R2 simulating the short circuit.

The following general characteristics can be derived:
the voltage UA und the current IA have an identical curve;
directly during the switch-on state, the voltage UA has a lower amplitude;
directly after switching-off, the voltage UA has a voltage gradient and an absolute value of 0 V.

FIG. 4A illustrates a circuit diagram corresponding to FIG. 2A and FIG. 3A for simulating an inductive load, wherein here the capacity C2 is not provided or switched, but instead an inductivity L3 with a parallel diode D1, which represent the inductive load, is switched.

FIG. 4B illustrates the result of simulation corresponding to FIG. 2B and FIG. 3B for an inductive load without short circuit. For the simulation of the inductive load without short circuit, the following values were used: R2=10 kΩ, R1=1 mΩ; L3=100 μH. Otherwise, possibly the same values of the parameters as in the FIGS. 2A, 2B, 2C were used.

The voltage UA rises abruptly and, after switching-off the switch M1, subsides almost abruptly, i.e., immediately, again, but drops to below zero, i.e., is negative. The voltage UA at the point in time T1 (here 30 μs) is UA(T1)=−844 mV, and the voltage at the point in time T2 (here 190 μs) is UA(T2)=−790 mV. Thus, the gradient of the voltage UA which can be expressed e.g. by the difference of the two voltages, i.e., ΔUA=UA(T1)−UA(T2), is positive. The current IA in the respective switch-off state is equal to zero and rises continuously while the switch is on.

The following general characteristics can be derived:
the current IA has a low current gradient;
the voltage UA has a very high amplitude, almost at the level of the input voltage;
no overcurrent condition during the switched-on phase;
directly after switching-off, the voltage UA has a positive voltage gradient and a negative absolute value.

FIG. 4C illustrates the result of simulation corresponding to FIG. 4B for an inductive load with short circuit, wherein R2=mΩ was used in the simulation here. Under the conditions otherwise identical to FIG. 4B, after switching-off, the voltage immediately drops to zero again. Thus, also the gradient of the voltage UA which can be expressed e.g. by the difference of the two voltages, i.e. ΔUA=UA(T1)−UA(T2), is equal to zero. The current IA in the respective switch-off state is equal to zero.

The following general characteristics can be derived:
the voltage UA and the current IA have an identical curve;
the voltage UA has a lower amplitude during the switch-on state;
overcurrent condition during the switched-on phase;
directly after switching-off, the voltage UA has a voltage gradient and an absolute value of 0 V.

On the basis of the above findings, at the beginning of a load being activated, a critical short circuit can be detected and, accordingly, the load can be deactivated.

FIG. 5 represents a diagram of a system in which the method according to the invention and the device according to the invention are used by way of example. A power supply and, resp., an electrical power source B (supplying a voltage UB) such as a battery, a generator or the like is connected to the input of a switch S and a monitoring unit or, resp., electronic control device SE as well as to a load L to supply the latter with electric power. The electronic control device receives the output current IA and the output voltage UA of the switch S from current and, resp., voltage sensors (not shown). The electronic control device SE itself can also include appropriate sensors to detect the output current IA and/or the output voltage UA. I.e., it is not relevant in which way the electronic control device SE receives information about the output current IA and the output voltage UA, as long as it is capable of receiving or determining said information in any way. The output current IA can also be replaced with or correspond to an input current of the load. Similarly, the output voltage UA can be replaced with or correspond to the input voltage of the load.

The electronic control device SE outputs a signal to control the switch S which is switched on or off in accordance with the signal. Said signal can be equivalent to a gate voltage, if e.g. a field effect transistor is used as a switch. Those skilled in the art are familiar with controlling a switch which may be a semiconductor switch, such as a field effect transistor or a bipolar transistor, therefore this shall not be explained in detail here. The only important thing is that the switch can be switched on and off in response to the signal of the electronic control device.

In general, the power input of a slow switching-on process is not or only insignificantly different from that of a quick switching-on. In the case of a capacitive load, for example, the charging resistance for the capacity is composed of the series connection of the resistances Ri (internal resistance of the electrical power source; ohmic-inductive, actually Zi) and of the resistance of the switch S (if MOSFET is the switch, this is R_{DS}). The power distribution depends on the ratio of R_{DS}/Ri. This charging process is carried out in the essential time range with R_{DS}=R_{DSon}. As a result, the ratio of R_{DS}/Ri becomes very small; the essential part of the power loss thus occurs in the area of the supply line and only a small part occurs in the area of the switch. Since the supply system has a by far higher thermal capacity and is in the range of >10 mΩ, more cost-efficient switches (in the range of R_{DSon} 1 mΩ) of very low thermal capacity can be used.

The load L is, as above-described, of the capacitive, ohmic or inductive type, with mixed forms being also possible and, thus, if the type is specified, the dominant type is specified or meant.

The switch S and the electronic control device SE together form a protective device according to the invention which can also be referred to as an electronic fuse. As above-described, the current and/or voltage sensor can, but need not, be part of the protective device.

Referring to FIGS. 6A and 6B, hereinafter a first embodiment of the invention will be described. At the start, in step S1 the switch S is switched on. After that, it is checked in step S2 whether the current IA is equal to or higher than an overcurrent threshold IA_S. Said overcurrent threshold IA_S serves for checking whether a current flows through the load which is higher than a current usually or expectedly flowing during operation of the load. The overcurrent threshold IA_S can also be exceeded in the event of an inrush current and, when operating the load, for example results in the load being deactivated or disconnected from the power supply. The overcurrent threshold IA_S preferably amounts to at least 70% of the nominal current of the load, but further preferably can also amount to at least 95% of the nominal current of the load, and yet further preferred is larger than the nominal current of the load or is selected such that the load and the system in which the load is used will not be damaged or defective, just as usually also in prior art an appropriate fuse is selected e.g. according to the application and, resp., to the nominal current of the load.

If the result of checking in step S2 is no, step S2 is repeated. However, in this case one can alternatively skip directly to the end of the flow diagram (“end” in FIG. 6B) so that then the normal operating process of the load can immediately follow, for example. If the result of checking in step S2 is yes, in step S3 the switch S is switched off again. Then, in step S4, measurement of a time t is started. This can be done via an incorporated timer or in any other known way. Then, in step S5, it is checked whether the measured time has reached a first time T1. This also involves that the measured time is longer than T1, depending on the accuracy of the time measurement, even if in the diagram of FIG. 6A only one inquiry regarding t=T1 is shown. The first time T1 can also be provided or determined, if the current IA after switching-off the switch has reached a stable value under supervision or ongoing measurement of the current IA, for example if between two current measuring times the value has changed only by less than 1%, preferably less than 0.1%. The first point in time T1 is, for example, at the most 100 ms after switching-off the switch, which is practical in the automotive sector. In other sectors, the first point in time T1 can be selected appropriately.

If the result of checking in step S5 is no, step S5 is repeated. If the result of checking in step S5 is yes, in step S6 the value of the voltage UA(T1) of said point in time T1 is stored. However, this can also mean that a part or the whole curve of the voltage UA is recorded or stored starting from switching-on the switch. The only important thing is that the voltage UA(T1) can later be used and is provided for further evaluation.

Then, in step S7, it is checked whether the measured time has reached a second time T2. This also involves that the measured time is longer than T2 depending on the accuracy of the time measurement, even if in the diagram of FIG. 6A only an inquiry regarding t=T2 is shown. The second time T2 e.g. is between 10 μs and 100 ms after the first time T1. The first time or first point in time T1 and the second time or second point in time T2 have to be selected or fixed only in such a way, however, that a reliable determination of the voltage gradient ΔUA is possible.

If the result of checking in step S7 is no, step S7 is repeated. If the result of checking in step S7 is yes, in step S8 the value of the voltage UA(T2) of said point in time T2 is stored. However, this can also mean that a part or the whole curve of the voltage UA is recorded or stored, starting from switching-on the switch. The only important thing is that the voltage UA(T2) can be used and is provided later for the further evaluation.

Then, in step S9, the difference ΔUA between the voltage UA(T2) of the point in time T2 and the voltage UA(T1) of the point in time T1 is determined. After that, in step S10, it is checked whether the voltage difference ΔUA is negative. Alternatively, it can be additionally checked in step S10 whether the amount or absolute value of the voltage difference is equal to or larger than a lower voltage difference threshold ΔUA_S2. In this way, it is possible to exclude faulty or inaccurate results regarding the voltage difference ΔUA which are very small and may also be due to measuring inaccuracies or the like. This contributes to an increase in the reliability of determining that a negative relevant voltage difference ΔUA is provided. Accordingly, the lower voltage difference threshold ΔUA_S2 is smaller, of course, than the upper voltage difference threshold ΔUA_S1 described in the following.

Further, in addition or as an alternative to a comparison of the absolute value of the voltage difference to the lower voltage difference threshold ΔUA_S2, it can be checked in step S10 or in a subsequent step whether the voltage UA after switching-off the switch is higher than zero, preferably higher than a third voltage threshold UA_S3 which is in a range between 10 and 100 mV, for example. If the voltage UA after switching-off is higher than zero or equal to or higher than the third voltage threshold UA_S3, it can be concluded therefrom that it is a capacitive load in a normal case, i.e. an uncritical case, so that in this case the switch can be switched on again (see step S12). This checking by means of the third voltage threshold UA_S3 can also be carried out instead of step S11. If the voltage UA after switching-off is equal to zero or lower than the third voltage threshold UA_S3, it is proceeded to step S13.

If the result of checking in step S10 is yes, i.e. the voltage difference or the gradient is negative, it is checked in step S11 whether the amount or absolute value of the voltage difference ΔUA is equal to or larger than an upper voltage difference threshold ΔUA_S1. If the result of checking in step S11 is yes, the switch-on process is considered to be uncritical and/or normal, and in step S12 the switch S is switched on again. If the result of checking in step S10 or in step S11 is no, i.e. the voltage difference or the gradient is below the upper threshold and/or is not negative, the switch-on process is considered to be critical and, resp., not normal, and for example in step S13 a corresponding fault message is output. The fault message can be visibly output to a driver or a maintenance person or can be stored only in the system itself. The output of a fault message is no substantial part of the invention, however. This is also applicable to the following description.

As explained above, specifically a short circuit is critical with a capacitive load and can lead to damage of the load and/or the system. Such a critical situation can be detected by the fact that, as above described, after switching-off the switch the voltage gradient with a capacitive load is negative and relatively high, i.e., exceeds the upper threshold. An exemplary value for the upper threshold ΔUA_S1 for the voltage difference and the voltage gradient, resp., is 200 mV/s. However, this is only a reference value and can be established e.g. in advance by means of experiments for different loads and the nominal values thereof. It must only be suitable to detect an abnormal case of a capacitive load as compared to a normal case of the capacitive load in which the voltage gradient is also negative but smaller than in a critical or, resp., abnormal case.

The admissible voltage gradient and, resp., the upper threshold ΔUA_S1 can also be determined depending on the voltage UA directly after switching-off the switch, such as within a time period from 100 to 1000 μs. The following applies: the higher the voltage UA directly after switching-off, the lower e.g. the capacity and, thus, the larger the voltage gradient occurring after switching-off. Accordingly, also the upper threshold ΔUA_S1 can be determined and/or adjusted.

The routine illustrated in FIG. 6B can also be replaced with the routine shown in FIG. 7B and described below, however.

Referring to FIGS. 7A and 7B, hereinafter a second embodiment of the invention will be described. Here, for the same steps as in the FIGS. 6A and 6B the same step numbers and reference symbols are used, and the description thereof is not repeated.

After step S1, in step S4 the above-described time measurement is started. After that, in step S21 the output current of the switch and, resp., the input current of the load or a comparable current IA is detected and stored and/or recorded. After that, in step S22, it is checked whether a predetermined period of time TD has elapsed since the switch S was switched on. If said period of time TD has elapsed, the switch S is switched off in step S3. If said period of time has not elapsed, step S22 is carried out again. Subsequently, the steps S5 and S10 are carried out as described above by means of FIGS. 6A and 6B. In contrast to FIG. 6B, however, if the result of inquiry in step S10 is no, i.e., if the voltage difference or the gradient is not negative, it is checked in step S23 whether while the switch was on, i.e., during the period of time TD, the current IA has been equal to or larger than the above-mentioned current threshold IA_S (see description concerning step S2). This may have been the case once or during a part of or during the whole period of time TD. This serves, as in step S2, for checking whether an overcurrent or inadmissibly high current has occurred. If the result of determination in step S23 is yes, i.e., if an overcurrent has occurred within the period of time TD, the above-described step S13 is carried out. If, on the other hand, the result of determination in step S23 is no, the switch S is switched on again in step S24, as no problem or no critical case has occurred.

Referring to FIG. 8, hereinafter a third embodiment of the invention will be described. The steps shown in FIG. 8 can be carried out following the steps shown in FIG. 6A or FIG. 7A. In this respect, the above description of the first and second embodiments is referred to. However, also the steps S31 and S32 shown in the Figures by broken lines are carried out which are not necessary in the first and second embodiments.

In step S31, it is checked whether the measured time has reached a preset time T0. This also involves that the measured time is greater than T1, depending on the accuracy of the time measurement, even if in the diagram only an inquiry regarding t=T0 is shown. The time T0 preferably is a time immediately after switching-off the switch or a time in direct vicinity thereto. The time T0 can also be later, however, even between the time T1 and the time T2 or after that, even if in FIG. 6A it is before the time T1, as long as at this point in time an unambiguous detection of the voltage UA after switching-off the switch is possible, the voltage UA being negative in the event of an inductive load. If the voltage UA(T0) is also used, however, to set or adjust the upper limit for the voltage gradient, i.e., ΔUA_S1, the time T0 preferably should be as close as possible after switching-off the switch to allow quick determination or adjustment of the threshold ΔUA_S1 for the further evaluation. It is conceivable even in that case, however, that the time T0 lies between the times T1 and T2 or corresponds to either of said times.

If the measured time has reached the time T0 (step S31: yes), in step S32 the voltage of said point in time is stored. However, instead generally the voltage curve of the voltage UA can be recorded already from beginning of switching-on the switch or else later or earlier up to the end of the process or earlier and can be stored for later use and evaluation. It is only important that the value of the voltage UA(T0) is available when it is required for further evaluation or calculation. This is also applicable to all other voltage and current values in all embodiments.

Now the explanation of FIG. 8 will follow, wherein the same steps as in FIGS. 6B and 7B are denoted with the same step numbers and reference symbols, resp., and the description thereof is not repeated. If the result of checking in step S10 is yes, i.e., if the sign of the voltage difference ΔUA is negative, it is initially judged in step S33 that it is a capacitive load, and this result is stored so that it can be accessed for later evaluations and processes. Only after that the above-described step S11 will be carried out.

If the result in step S23 is yes, i.e., if an overcurrent has occurred while the switch was on, it is checked in step S37 whether the voltage in the switch-on state of the switch UA(Tein) was equal to or lower than a first voltage threshold UA_S1. The first voltage threshold UA_S1 is set such that it can be determined by comparison to the same whether the voltage UA in the switch-on state of the switch S was lower than in a normal case. In particular, the threshold is equal to or less than 0 V. The threshold can preferably be derived from the accuracy of the measuring system. The threshold can typically amount to −100 mV (or be in a range about said value).

In the event of a short circuit of an ohmic load, this case occurs so that, in the event of a positive result in step S37, it is determined in the subsequent step S38 that it is an ohmic load, and this result is stored for a later possible use or evaluation. After that, in the above-described step S13, the output of a fault message will follow which in this case can also include the result that it is an ohmic load.

If, on the other hand, the result of checking in step S37 is negative, it is determined in the subsequent step S39 that it is an inductive load, and the result is stored for a later possible use or evaluation.

If the result of determination in step S23 is no, i.e. if no overcurrent has occurred, for further detection of the type of load (ohmic load or inductive load) it is determined in step S34 whether the value of the voltage UA(T0) at the point in time T0, which was described above, is smaller than a second voltage threshold UA_S2. The second voltage threshold UA_S2 serves to check whether the voltage UA after switching-off the switch was or is negative, as it occurs with an inductive load in a normal case. If, therefore, the result of determination in step S34 is yes, it is judged in step S35 that it is an inductive load, and this result is stored for a possible later use or evaluation. After that, the switch S is switched on again in step S24.

If, on the other hand, the result of determination in step S34 is no, it is judged in step S36 that it is an ohmic load, and this result is stored for a possible later use or evaluation. After that, the switch S is switched on again in step S24.

In FIG. 8, however, the steps for determining and characterizing the load as an ohmic or inductive load can also be omitted so that only a characterization of the load as a capacitive load (or as no capacitive load) is performed. This would result, for example, in step S33 being inserted after step S10 in the FIGS. 6B and/or 7B.

It is referred to the fact that, due to the broad load spectrum which is to be protected by a fuse device according to the invention, as already indicated above, a uniform parameterization for all loads and applications, respectively, is hardly possible. It is the object of the following example of parameterization to safely but also quickly detect short circuits so that, in the optimum case, the short circuit is detected within very short time, or in the case that no short circuit is provided, very quick switching-on of the load branch is possible. The minimum times are defined by the respective measuring system used and the uncertainty thereof.

The current state of the art relates to measurement cycles for currents and voltages in the range from 10 to 100 μs. The voltage gradient in the event of capacitive loads is substantially determined by the capacity value of the input capacity and the initial discharge current. Since, usually, the initializing current is by far lower than the operating current, and the input capacity is designed for the operating current, the voltage gradients in faultless operation can be assumed to range from <100 to 200 mV/s. If the conditions in an individual case deviate from the standard conditions, the parameters can be adjusted according to the following parameterization recipe:
1. Determining the individual measuring time for safe voltage values (data sheet, circuit analysis of the specific load).
2. The minimum observation time of the voltage UA should be in the range from 5 to measuring times of item 1.
3. The start of measuring the voltage gradient depends on the voltage curve after switching-off. The earliest starting time should be selected so that the switch S is safely completely open.
4. Determining the voltage gradient (e.g. with oscilloscope) in the GOOD case (no fault).
5. Determining the voltage gradient in the BAD case. Here an ohmic extra load (R_Zusatz) is connected in parallel to the load. The value of R_Zusatz is calculated from: R_Zusatz=Unom/Inom;
Unom: nominal operating voltage of the load to be protected;
Inom: nominal switch-off current of the load to be protected;
6. The limit for discriminating short circuit vs. inrush current or normal start-up current can be selected correspondingly (depending on the priority “safe switching-on” or “in the fault case safe non-switching-on”) in the range between the limits measured under item 4 and item 5.
7. The typical value for the measuring time (T2−T1) is in the range from 100 to 1000 μs. If the difference of the two determined limits of item 4 and item 5 is too small, i.e. if the measuring system cannot safely allocate the voltage gradients, the system can be rendered safer by extending the measuring time (T2−T1). Due to the longer measuring time, the discharge is possibly increased and the absolute voltages is correspondingly better distinguishable; the starting procedure is thus extended. If the priority is on the period of the starting procedure, a shorter measuring time (T2−T1) can be selected, if necessary, by a very quick switch and a very quick measuring unit.

It is clear from this that the method according to the invention can also be carried out repeatedly to perform learning of the load and, resp., the corresponding parameters to increase the accuracy. The results derived from the method according to the invention can be stored for the further use and/or adjustment or correction. In a motor vehicle, this can be done already during or immediately after manufacture or at a dealer.

In the following, a fourth embodiment of the invention will be described with reference to FIGS. 9 to 11. In FIG. 9, plural loads L1 to Ln, i.e., a capacitive load L1, an ohmic load L2, an inductive load L3 and further loads Ln which may be capacitive, ohmic and/or inductive loads are connected to an electrical power source B via respective associated switches S1 to Sn which include respective transistors M1 to Mn such as a MOSFET, for example. Regarding the switches S1 to Sn, the above description of the switch S is referred to. I.e., each switch S1 to Sn can be a respective above-described switch S. Regarding the loads L1 to Ln, the above description of the load L is referred to. I.e., each load L1 to Ln can be a respective above-described load L. The switches S1 to Sn are individually controlled, i.e., switched on and off, by an electronic control device SE′. Respective voltages above the loads L1 to Ln and respective output voltages U1 to Un of the switches S1 to Sn are tapped by or input into the electronic control device SE′. Corresponding voltage sensors or voltage measuring devices are contained in the electronic control device SE′, but can also be provided partly or completely outside the electronic control device SE′ for measuring the output voltages U1 to Un. As an alternative, the output voltages U1 to Un can be determined also in a different way, such as indirectly via a respective current measurement of the currs 11 to In of the loads L1 to Ln.

In addition, the electronic control device SE′ receives the summation current IS of the currents of the switches S1 to Sn which can be considered to be equivalent to the load currs 11 to In. The electronic control device SE′ switches off or deactivates all switches, if or when the summation current IS exceeds a predetermined summation current threshold. The technique or procedure of an electronic fuse with summation current measurement and corresponding switching-off is known and, therefore, is not described in detail. The electronic control device SE′ can be identical to the above-described control device SE with an extended functionality or can be a different control device.

By way of FIGS. 10 and 11, an exemplary flow of a method according to the fourth embodiment which is carried out by the electronic control device SE′ shall be described in the following. Accordingly, initially it is assumed that the type of loads, at least of the capacitive loads, is known and corresponding information can be accessed by the electronic control unit SE′. In step S41 (see FIG. 10) during operation of the loads L1 to Ln, the summation current IS is determined, for example measured, and is compared to a fuse threshold or summation current threshold IS_S. If the summation current IS is not higher than the summation current threshold IS_S, step S41 is repeated. If the summation current IS is higher than the summation current threshold IS_S, in step S42 all switches S1 to Sn are switched off. Then, in step S43, it is checked for the capacitive loads, in the example here at least the load L1, whether the voltage U1 thereof or the output voltage of the associated switch S1 thereof is less than a voltage threshold U_S. The voltage threshold U_S can be set appropriately for the load, the switch and/or the application sector and is designed so that a short circuit can be determined when the voltage threshold is exceeded. Regarding possible values, the above explanations are referred to.

If in step S43 the output voltage U1 is not equal to or higher than the voltage threshold US_S, a short circuit occurs in the respective capacitive load L1, and in step S45 a corresponding fault information is stored for later use. The step S45 can also be omitted, however.

If in step S43 the output voltage U1 is equal to or higher than the voltage threshold U_S, it is checked in step S44 whether the determination period has elapsed. The determination period should be as short as possible, but also long enough to measure the output voltage and evaluate it with respect to a short circuit. The determination period can be in a range from 10 to 20 μs. If the determination period has not elapsed, it is returned to step S43. If the determination period has elapsed, in step S46 the corresponding switch S1 is again switched on, as no short circuit occurs in this capacitive load L1. Accordingly, a corresponding information about the fact that no short circuit occurs in the capacitive load L1 can be stored. The flow for the capacitive loads is thus terminated.

Further, if there are ohmic and/or inductive loads to be checked, after the determination period has elapsed in step S44, it is proceeded to step S51 (FIG. 11) in which a (selected) inductive or ohmic switch S2, S3 is switched on. Then it is checked in step S52 whether the current I2, I3 flowing through the switch or the corresponding load exceeds an overcurrent threshold IS_S. This can be checked very quickly, as in the event of short circuit after switching-on the current rises very quickly and exceeds the overcurrent threshold. For example, a period of time of 10 μs can be sufficient, as it is shown, e.g., by means of the period of time between TE and TA in FIGS. 2 to 4.

If the overcurrent threshold IS_S is exceeded within the above period of time for checking a short circuit, in step S53 the corresponding switch is switched off, and in step S54 a corresponding fault information is stored for later use. Step S54 can also be omitted, or can be carried out prior to or in parallel to the step S53. After that, step S55 is carried out in which it is inquired whether all ohmic and/or inductive loads to be checked were checked. Step S55 is also carried out directly following step S52, if the overcurrent threshold IS_S is not exceeded within the above period of time for checking a short circuit. Accordingly, corresponding information about the fact that no short circuit occurs in the load can also be stored.

If in step S55 all ohmic and/or inductive loads to be checked were not yet checked, it is returned to step S51, and the procedure for a next (selected) ohmic or inductive load is carried out. If, on the other hand, all ohmic and/or inductive loads to be checked were checked, the procedure is terminated.

The procedure in FIG. 10 can also be terminated after step S46 or S45 without proceeding to the procedure in FIG. 11 (S51) (see broken line after step S46 in FIG. 10). This may also depend on whether or not there are provided ohmic and/or inductive loads to be checked.

1. A method of protecting an electrical load (L) in the event of a short circuit of the load (L), the electrical load (L) being configured to be connectable via a switch (S) to an electrical power source (B), the method comprising the steps of:
connecting the load (L) to the electrical power source (B) by a first switching-on of the switch (S),
detecting an output current (IA) of the switch (S),
switching off the switch (S), when the output current (IA) exceeds an overcurrent threshold (IA_S) and/or a predetermined period of time (TD) has elapsed since performing the first switching-on of the switch (S),
detecting an output voltage (UA) of the switch (S),
determining an output voltage difference (ΔUA) of the output voltage (UA) between a predetermined first point in time (T1) and a predetermined second point in time (T2) after the first point in time (T1),
second switching-on of the switch (S), when
the output voltage difference (ΔUA) is negative and has an absolute value which is less than an upper output voltage difference threshold (ΔUA_S1), and/or
the switch (S) was switched off after the predetermined period of time (TD) and the detected output current (IA) has not exceeded the overcurrent threshold (IA_S) since the first switching-on at least until the switching-off.

2. (canceled)

3. (canceled)

4. (canceled)

5. The method according to claim 1, wherein
the first point in time (T1) is equal to the point in time (TA) of switching off the switch (S) or is after the point in time (TA) of switching off the switch (S).

6. The method according to claim 1, wherein
the second point in time (T2) is in a range from 100 to 1000 μs after the first point in time (T1).

7. The method according to claim 1, wherein
the upper output voltage difference threshold (ΔUA_S1) is set as a function of the output voltage (UA) after the switching-off the switch (S).

8. The method according to claim 1, wherein
an initial value of the upper output voltage difference threshold (ΔUA_S1) is in a range from 100 to 200 mV/s.

9. The method according to claim 1, wherein the load (L) is a vehicle load, specifically a motor vehicle load.

10. The method according to claim 1 that is carried out at the beginning of switching-on operation of the load (L) for operating the same.

11. The method according to claim 1, wherein,
when after the first switching-on of the switch (S) the output current (IA) has exceeded the overcurrent threshold (IA_S) and the output voltage difference (ΔUA) is negative, it is determined that the load (L) is a capacitive load.

12. (canceled)

13. A device for protecting an electrical load (L) in the event of a short circuit of the load (L), the electrical load (L) connecting the load (L) to and disconnecting it from an electrical power source (B), the device comprising:
a switch (S) which, when switched on, connects the load (L) to the electrical power source (B),
a current sensor for detecting an output current (IA) of the switch (S),
a voltage sensor for detecting an output voltage (UA) of the switch (S), and
an electronic control device (SE) connected to the switch (S), the current sensor and the voltage sensor, wherein
the electronic control device (SE) is configured to perform:
first switching-on of the switch (S) and afterwards a switching-off of the switch (S), when the output current (IA) exceeds an overcurrent threshold (IA_S) and/or a predetermined period of time (TD) has elapsed since the first switching-on of the switch (S) was performed,
determining an output voltage difference (ΔUA) of the output voltage (UA) between a predetermined first point in time (T1) and a predetermined second point in time (T2) after the first point in time (T1), and
again switching on the switch (S), when
the output voltage difference (ΔUA) is negative and has an absolute value that is less than an upper output voltage difference threshold (ΔUA_S1), and/or
the switch (S) was switched off after the predetermined period of time (TD) and the detected output current (IA) has not exceeded the overcurrent threshold (IA_S) since the first switching-on of the switch at least until the switching-off of the switch.

14. A device for protecting an electrical load (L) in the event of a short circuit of the load (L), comprising a switch (S) which can be switched between the load (L) and an electrical power source (B), the device being configured to carry out a method according to claim 1.

15. A method of protecting a plurality of electrical loads (L1 to Ln) connectable to an electrical power source (B) via respective switches (S1 to Sn) in the event of a short circuit of at least one of the loads (L1 to Ln), wherein a sum of respective currents (I1 to In) of the loads (L1 to Ln) is detected as a summation current (IS), and wherein, when the summation current (IS) exceeds a predetermined summation current threshold, the switches (S1 to Sn) are switched off, the method comprising:
after switching-off the switch (S1 to Sn) due to the summation current (IS) exceeding the summation current threshold,
for at least a first switch (S1) among the switches (S1 to Sn) which is associated with a capacitive load (L1) among the loads (L1 to Ln):
detecting an output voltage (U1) of the first switch (S1) during a predetermined detection period after the switching-off the first switch (S1),
if the output voltage (U1) during the predetermined detection period is or becomes less than a predetermined voltage threshold, maintaining the switch-off state of the first switch (S1),
if the output voltage (U1) during the predetermined detection period is or becomes not less than the predetermined voltage threshold, switching on the first switch (S1) after expiry of the predetermined detection period.

16. The method of protecting a plurality of electrical loads (L1 to Ln) according to claim 15, further comprising:
after switching-off the switches (S1 to Sn) due to the summation current (IS) exceeding the summation current threshold,
for at least a second switch (S2, S3) among the switches (S1 to Sn) which is associated with an ohmic or inductive load (L2, L3) among the loads (L1 to Ln):
switching on the second switch (S2, S3) and determining a current (I2, I3) flowing through the second switch (S2, S3), and
switching off the second switch (S2, S3), when the established current (I2, I3) exceeds an overcurrent threshold.

17. The method of protecting a plurality of electrical loads (L1 to Ln) according to claim 16, wherein the switching-on the second switch (S2, S3), the determining the current (I2, I3) flowing through the second switch (S2, S3) and the switching-off the second switch (S2, S3) are carried out sequentially for several or all of the second switches (S2, S3).

18. The method of protecting a plurality of electrical loads (L1 to Ln) according to claim 16, wherein the switching-on the second switch (S2, S3), the determining the current (I2, I3) flowing through the second switch (S2, S3) and the switching-off the second switch (S2, S3) are carried out after the predetermined detection period has expired.

19. The method of protecting a plurality of electrical loads (L1 to Ln) according to claim 15, wherein the predetermined detection period is less than or equal to 100 μs, preferably less than or equal to 20 μs.

20. The method of protecting a plurality of electrical loads (L1 to Ln) according to claim 15, wherein the predetermined voltage threshold is equal to or less than 5 volts, preferably equal to or less than 3 volts.

21. The method of protecting a plurality of electrical loads (L1 to Ln) according to claim 15, wherein, if the output voltage (U1) during the predetermined detection period is less than the predetermined voltage threshold, a corresponding first fault information is stored in association with the capacitive load (L1) associated with the first switch (S1).

22. The method of protecting a plurality of electrical loads (L1 to Ln) according to claim 15, wherein, if the established current (I2, I3) exceeds an overcurrent threshold, a corresponding second fault information is stored in association with the ohmic or inductive load (L2, L3) associated with the second switch (S2, S3).

23. The method of protecting a plurality of electrical loads (L1 to Ln) according to claim 15, wherein information about a respective type of the specific loads (L1 to Ln) are stored in advance and reference is made to said information.

24. (canceled)

25. A device for protecting a plurality of electrical loads (L1 to Ln) in the event of a short circuit of at least one of the loads (L1 to Ln) by means of respective switches (S1 to Sn) associated with the respective loads (L1 to Ln), the respective switches (S1 to Sn) being switchable between the corresponding loads (L1 to Ln) and an electrical power source (B), wherein the device is configured to carry out a method according to claim 15.
